(19) United States
(12) Patent Application Publication
(10) Pub. No.: US 2010/0047918 A1
(43) Pub. Date: Feb. 25, 2010

(54) TEST-SENSOR CARTRIDGE

(76) Inventor: John P. Creaven, Granger, IN (US)

Correspondence Address: NIXON PEABODY LLP, 300 S. Riverside Plaza, 16th Floor, CHICAGO, IL, 60606-6613, US

(21) Appl. No.: 12/447,778

(22) PCT Filed: Nov. 6, 2007
(86) PCT No.: PCT/US07/23366

§ 371 Date: Apr. 29, 2009

Related U.S. Application Data
(60) Provisional application No. 60/858,210, filed on Nov. 9, 2006.

(51) Int. Cl. G01N 21/75; G01N 31/22; B23P 11/00

(52) U.S. Cl. 436/164; 422/58; 29/428

(57) ABSTRACT

A test-sensor cartridge including a plurality of test sensors adapted to assist in determining an analyte concentration of a fluid sample. The test-sensor cartridge further includes a housing forming a cavity. The cavity is adapted to contain the plurality of test sensors. The test-sensor cartridge further includes a lid adapted to enclose the cavity. The test-sensor cartridge further includes a closing feature adapted to maintain the lid in a closed position. The closing feature is distorted when the lid is in an open position and generally released when the lid is in a closed position.

### FIELD OF THE INVENTION

The present invention relates generally to sensor-dispensing instruments and, more particularly, to test-sensor cartridges for minimizing the exposure of test sensors within the cartridge to the environment.

### BACKGROUND OF THE INVENTION

The quantitative determination of analytes in body fluids is of great importance in the diagnoses and maintenance of certain physiological abnormalities. For example, lactate, cholesterol, and bilirubin should be monitored in certain individuals. In particular, determining glucose in body fluids is important to diabetic individuals who must frequently check the glucose level in their body fluids to regulate the glucose intake in their diets. The results of such tests may be used to determine what, if any, insulin and/or other medication needs to be administered. In one type of testing system, test sensors are used to test a fluid such as a sample of blood.

One method of monitoring an individual's blood glucose level is with a portable, hand-held blood glucose testing device (e.g., a meter). To determine the blood glucose level with the meter, a lancet device may be used with a needle lancet that pierces the skin tissue and allows a whole blood sample to form on the skin's surface. Once the requisite amount of blood forms on the skin's surface, the blood sample is transferred to a test sensor. The test sensor is generally placed in an opening in the body of the meter.

Test-sensor cartridges are commonly used to individually dispense test sensors to be used for testing an analyte in a fluid. The cartridges are used to store multiple sensors and allow users to carry multiple sensors around within a single enclosure. During testing, a blood or body fluid sample may be placed on the sensor and analyzed with the meter or instrument to determine the concentration of the analyte being examined.

The test-sensor cartridges may be incorporated directly into, for example, glucose meters to dispense test sensors for use with the meter. The cartridges may include features designed to mate with corresponding features inside of the meter to assist in indexing and/or excising the test sensors located within the cartridges. Alternatively, the cartridges may be kept separate from the meter. In such embodiments, a user may remove a single sensor from the cartridge to perform an analyte test. When closed, the cartridges assist in preventing or inhibiting test sensors from being exposed to the environment until the sensors are required for use.

Many existing test-sensor cartridges require that a user perform some affirmative act to close the lid of the cartridge after a test sensor has been removed therefrom. For example, the user may need to screw a cap back onto the cartridge, flip the lid so that it is in a closed position, or the like. Re-closing the lid of the cartridge (e.g., screwing on the cap) may be difficult for some users, as significant effort may be required. Oftentimes, however, the user minimizes the importance of closing the cartridge and/or forgets to close the cartridge. When the cartridge is left open, the test sensors within the cartridge are undesirably exposed to the environment, often for extended periods of time.

The exposure to humidity, contaminants, or other environmental factors may damage the test sensors, thereby altering test results. Inaccurate test results may result in dangerous analyte levels (e.g., hyperglycemic or hypoglycemic conditions) being undetected, which may be dangerous for a user and may have serious health-related consequences. Damaged test sensors that have been exposed to the environment for extended periods of time may require that additional, undamaged sensors be purchased and used, which is inconvenient and expensive for a user.

It would be desirable to provide test-sensor cartridges that assist in addressing one or more of these disadvantages.

### SUMMARY OF THE INVENTION

According to one embodiment of the present invention, a test-sensor cartridge comprises a plurality of test sensors adapted to assist in determining an analyte concentration of a fluid sample. The test-sensor cartridge further comprises a housing forming a cavity. The cavity is adapted to contain the plurality of test sensors. The test-sensor cartridge further comprises a lid adapted to enclose the cavity. The test-sensor cartridge further comprises a closing feature adapted to maintain the lid in a closed position. The closing feature is distorted when the lid is in an open position and generally released when the lid is in a closed position.

According to one process of the present invention, a method of using a test-sensor cartridge including a housing forming a cavity adapted to contain a plurality of test sensors adapted to assist in determining an analyte concentration of a fluid sample, the cartridge further including a lid enclosing the cavity, the lid being hingedly coupled to the housing is disclosed. The method comprises the acts of applying a force to the lid to open the lid. The force causes a closing feature to become distorted. A first end of the closing feature is attached to the housing, and a second, opposing end of the closing feature is attached to the lid. The method further comprises removing a test sensor from the cavity while applying the force to the lid. The method further comprises releasing the force to close the lid. The releasing causes the closing feature to generally recover its initial shape.

According to another process of the present invention, a method of making a test-sensor cartridge comprises the acts of providing a housing forming a cavity adapted to contain a plurality of test sensors adapted to assist in determining an analyte concentration of a fluid sample. The method further comprises enclosing the cavity using a lid. The lid is hingedly coupled to the housing. The method further comprises coupling a closing feature to the housing and the lid. The closing feature is adapted to maintain the lid in a closed position. The closing feature is distorted when the lid is in an open position and is generally released when the lid is in a closed position.

The above summary of the present invention is not intended to represent each embodiment or every aspect of the present invention. Additional features and benefits of the present invention are apparent from the detailed description and figures set forth below.

### BRIEF DESCRIPTION OF THE DRAWINGS

FIG. 1a is a top view of a test sensor according to one embodiment.

FIG. 1b is a top view of a test sensor according to another embodiment.

FIG. 2 is a side view of a test-sensor cartridge according to one embodiment.

FIG. 3a is a top perspective view of a test-sensor cartridge according to one embodiment.

FIG. 3b is a side view of the cartridge of FIG. 3a in a closed position.

FIG. 3c is a side view of the cartridge of FIGS. 3a,b in an open position.

FIG. 4a is a side view of a test-sensor cartridge according to another embodiment.

FIG. 4b is a side view of the cartridge of FIG. 4a in an open position.

### DESCRIPTION OF ILLUSTRATED EMBODIMENTS

The present invention is directed to inhibiting or preventing test sensors within a test-sensor cartridge from being unnecessarily exposed to the environment for extended periods of time. The test sensors (e.g., biosensors) excised from the cartridge may be used to assist in determining an analyte concentration in a fluid sample. Some examples of the types of analytes that may be collected and analyzed include glucose, lipid profiles (e.g., cholesterol, triglycerides, LDL, and HDL), microalbumin, hemoglobin, A_{1C}, fructose, lactate, or bilirubin. The present invention is not limited, however, to these specific analytes, and it is contemplated that other analyte concentrations may be determined. The analytes may be in, for example, a whole blood sample, a blood serum sample, a blood plasma sample, or other body fluids like ISF (interstitial fluid) and/or urine. One non-limiting example of a use of the test-sensor cartridge and meter is to determine the glucose concentration in a user's blood, plasma, or ISF.

Test sensors used in determining analyte concentrations in one embodiment include a capillary channel that extends from the front or testing end of the test sensor to biosensing or reagent material disposed in the test sensor. The reagent generally includes an appropriately selected enzyme to react with the desired analyte or analytes to be tested. The reagent may be stored within the test sensor in a dried solution/liquid form to promote an extended shelf life of the test sensor. When the testing end of the test sensor is placed into fluid (e.g., blood that has accumulated on a person's finger after the finger has been pricked), a portion of the fluid is drawn into the capillary channel by capillary action. The fluid then mixes with the reagent material in the test sensor and chemically reacts with the reagent material so that an electrical signal indicative of the analyte (e.g., glucose) level in the fluid being tested is supplied and subsequently transmitted to a meter.

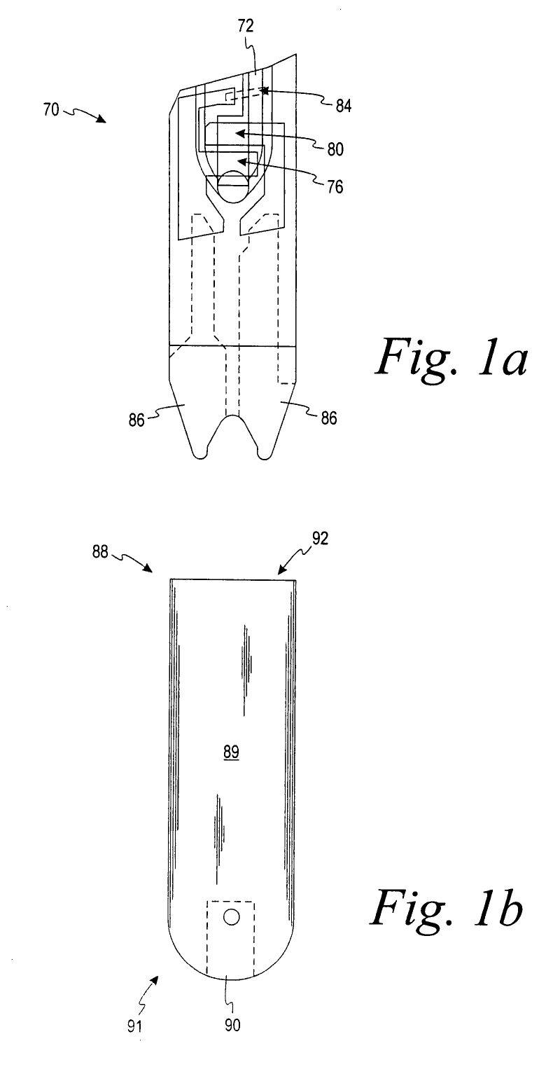

One type of test sensor that may be used is an electrochemical test sensor. One non-limiting example of an electrochemical test sensor is shown in FIG. 1a. FIG. 1a depicts a test sensor 70 that includes a capillary channel 72, an area for meter contacts 86, and a plurality of electrodes 76, 80, 84. The capillary channel 72 contains reagent. The plurality of electrodes includes a counter electrode 76, a working (measuring) electrode 80, and an optional trigger electrode 84. The trigger electrode 84 may assist in determining whether a sufficient blood sample has been placed on the sensor 70. The electrochemical test sensor may also contain other numbers and/or types of electrodes. Examples of electrochemical test sensors, including their operation, may be found in, for example, U.S. Pat. No. 6,531,040 assigned to Bayer Corporation. It is contemplated that other electrochemical test sensors may be employed. It is also contemplated that other types of test sensors may be used including, but not limited to, optical test sensors.

FIG. 1b shows an optical test sensor 88 according to one embodiment. The test sensor 88 includes a base (not shown), a lid 89, and a spacer (not shown) positioned between the lid 89 and the base. The base, the lid 89, and the spacer may be made from a variety of materials such as polymeric materials. Non-limiting examples of polymeric materials that may be used to form the base, lid and spacer include polycarbonate, polyethylene terephthalate (PET), polyethylene naphthalate (PEN), polyimide, and combinations thereof. When the base, the lid 89, and the spacer are attached together, a fluid-receiving area 90 is formed. The fluid-receiving area provides a flow path for introducing the fluid sample into the test sensor 88. The fluid-receiving area 90 is formed at a first end or testing end 91 of the test sensor 88. The test sensor 88 includes a second opposing end 92. The second opposing end 92 is adapted to be placed into a meter or instrument.

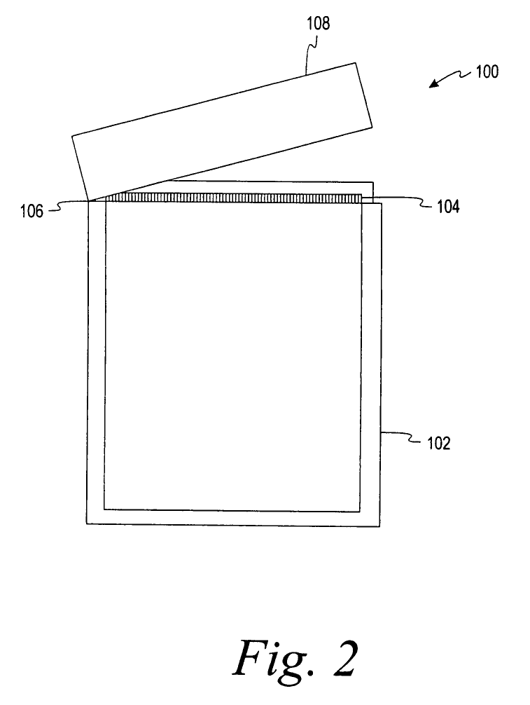

A plurality of test sensors may be stored in a disposable test-sensor cartridge. One example of a disposable cartridge 100 is depicted in FIG. 2. The disposable cartridge 100 of FIG. 2 comprises a housing 102, a plurality of stacked test sensors 104, a hinge mechanism 106, and a lid 108. The cartridge 100 is adapted to be disposed of after each of the test sensors 104 has been removed and used. It is also contemplated that the cartridge 100 may be refilled and, thus, reused. The desiccant compartment of a reusable cartridge generally should be replaced when the reusable cartridge is refilled.

The test-sensor cartridges of the embodiments described herein include a closing feature for maintaining the lid of the cartridges in a closed position. The closing feature may be a coiled spring, a flat spring, a flexible piece of material, a molded hinge attached to the cartridge, combinations thereof, or the like. The closing feature allows the lid to be opened by applying a force (e.g., pushing or pulling) to the lid or a portion thereof. When the force ceases to be applied, the closing feature causes the lid to close. The closing feature thus assists in inhibiting or preventing the test sensors housed within the cartridge from being unnecessarily exposed to the environment (e.g., humidity, contaminants, and the like) for prolonged periods of time.

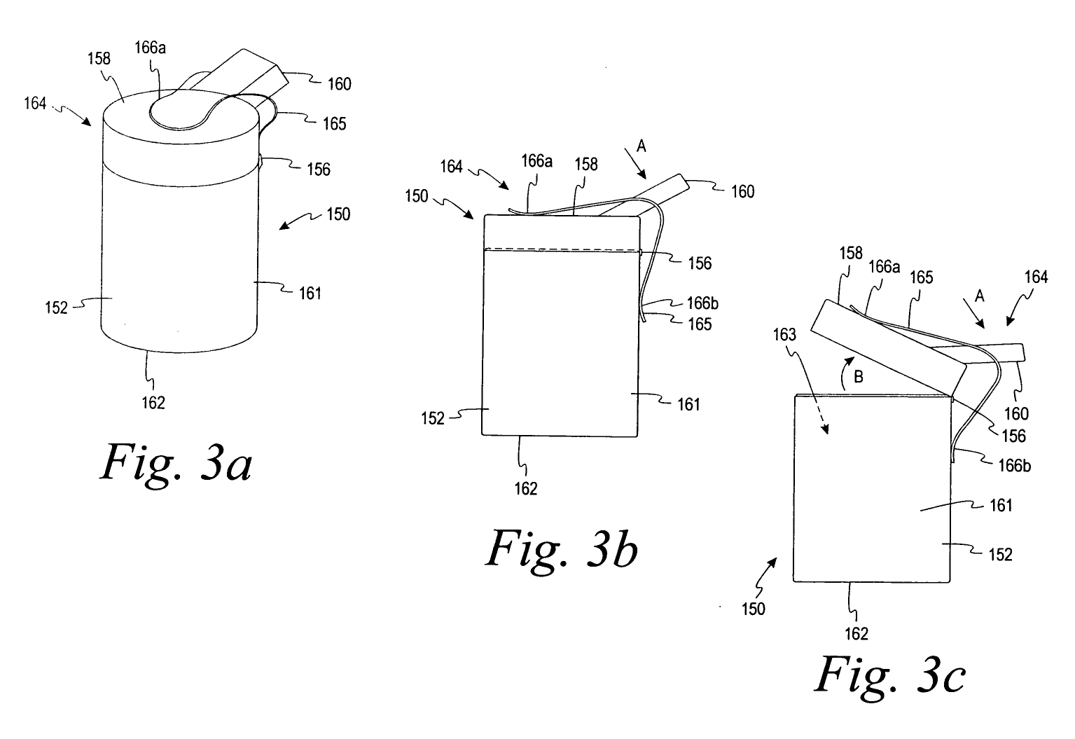

In the embodiment of FIGS. 3a,b, for example, a test-sensor cartridge 150 having an external closing feature is shown. Like the cartridge 100 of FIG. 2, the cartridge 150 comprises a housing 152, a hinge mechanism 156, and a lid 158. The cartridge 150 further includes a latch 160. Although in the embodiment of FIGS. 3a-c, the cartridge 150 is generally round, it is contemplated that the cartridge may be any suitable shape including, but not limited to, rectangular and other polygonal and non-polygonal shapes. The housing 152 includes at least one wall 161 and a bottom 162 forming a cavity 163 adapted to hold a plurality of stacked test sensors (not shown) therein. The lid 158 is positioned at a top end 164 of the cartridge 150 and is adapted to enclose the cavity 163. The lid 158 may generally form a seal with the cartridge 150 when the cartridge 150 is in the closed position of FIG. 3b such that humidity, contaminants, or the like may not seep into the cartridge 150. The external closing feature of the cartridge 150 includes a flat spring 165 coupled to the cartridge 150. A top portion 166a of the flat spring 165 is coupled to the lid 158, and a bottom portion 166b of the flat spring 165 is coupled to the housing 152. Other suitable types of external closing features may also be used.

To open the cartridge 150, a user may apply a force (e.g., press) to the latch 160 in the direction of Arrow A. In embodiments where the cartridge does not include a latch, the user may lift the lid to open the cartridge or use any other suitable way of opening the cartridge. As the user applies the force, the lid 158 pivots about the hinge mechanism 156 in the direction of Arrow B, thereby opening the cartridge 150 (see FIG. 3c). The user may then remove a test sensor (not shown) housed within the cartridge 150 (e.g., by placing his or her finger(s) within the cartridge 150, by tipping the cartridge 150 slightly so that a sensor falls out from the cartridge 150, or the like). When the cartridge 150 is in an open position (FIG. 3c), a force is applied to the flat spring 165 causing the flat spring 165 to flex and become distorted. Once the sensor is removed, the user may release the latch 160, causing the flat spring 165 to release and generally recover its initial shape. The flat spring 165 thereby forces the lid 158 back into the closed position of FIG. 3b.

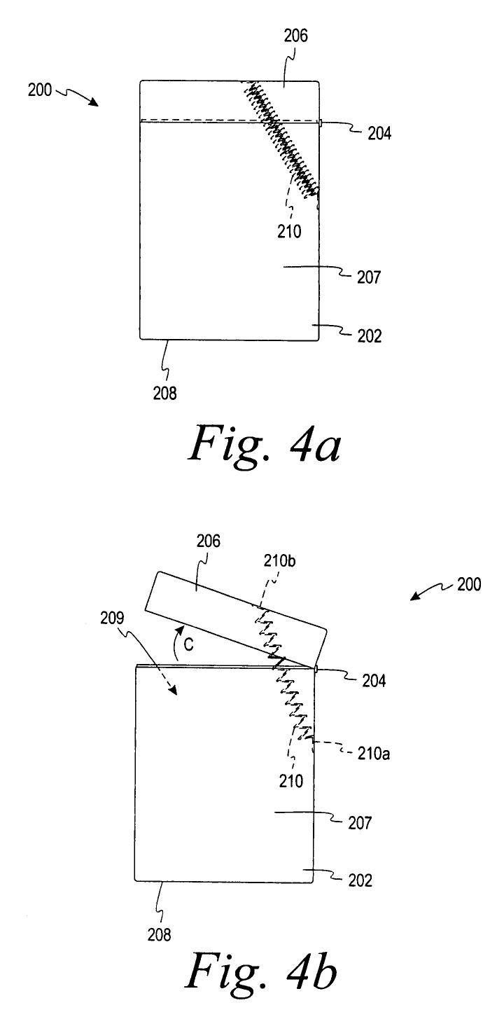

Referring now to FIGS. 4a-b, a cartridge 200 is shown according to another embodiment. The cartridge 200 is generally similar in structure and characteristics to the cartridge 150 of FIGS. 3a-c. Specifically, the cartridge 200 comprises a housing 202, a hinge mechanism 204, and a lid 206. The housing 202 includes at least one wall 207 and a bottom 208 forming a cavity 209 adapted to hold a plurality of stacked test sensors (not shown) therein. The cartridge 200 of FIGS. 4a-b, however, includes an internal closing feature. The internal closing feature of the cartridge 200 includes a coiled spring 210. One end 210a of the coiled spring 210 is coupled to an interior surface of the cartridge 200, and a second, opposite end 210b of the coiled spring 210 is coupled to an interior surface of the lid 206.

To open the cartridge 200, a user may apply a force (e.g., lift) the lid 206 in the direction of Arrow C. The lid 206 then pivots about the hinge mechanism 204 in the direction of Arrow C, thereby opening the cartridge 200 (see FIG. 4b). The user may then remove a test sensor (not shown) housed within the cartridge 200. When the cartridge 200 is in an open position (FIG. 4b), the coiled spring 210 extends and becomes distorted. Once the sensor is removed, the user may release the lid 206, causing the coiled spring 210 to compress and generally recover its initial shape. The coiled spring 210 thereby forces the lid 206 back into the closed position of FIG. 4a. It is contemplated that other types of internal closing features may be also used including, but not limited to, a flat spring (e.g., the flat spring 164 of FIGS. 3a-c).

Because a force must be applied to maintain the cartridges of the embodiments described herein in an open position (see FIG. 3c), when the force is released, the closing feature of the cartridges force the cartridges to return to a closed position (see FIGS. 3b, 4b). Thus, the likelihood that a user will forget or choose not to close the cartridge is significantly reduced or eliminated. The cartridges may therefore assist in reducing the exposure of the test sensors housed within the cartridges to humidity, contaminants, and other potentially damaging aspects of the environment. Thus, the cartridges may reduce damage to test sensors housed within the cartridges, thereby improving the overall accuracy of analyte-testing results.

The cartridges in the embodiments described herein also have other advantages. For example, because the cartridges may not be opened without a user applying a force to a portion of the cartridge (e.g., the lid), the cartridges are generally childproof. The cartridges and/or the lids thereof may also include a locking feature to further childproof the respective cartridges.

### ALTERNATIVE EMBODIMENT A

A test-sensor cartridge comprising:
a plurality of test sensors adapted to assist in determining an analyte concentration of a fluid sample;
a housing forming a cavity, the cavity being adapted to contain the plurality of test sensors;
a lid adapted to enclose the cavity; and
a closing feature adapted to maintain the lid in a closed position, the closing feature being distorted when the lid is in an open position and generally released when the lid is in a closed position.

### ALTERNATIVE EMBODIMENT B

The cartridge of Alternative Embodiment A, wherein the closing feature includes a flat spring being attached to the housing and the lid.

### ALTERNATIVE EMBODIMENT C

The cartridge of Alternative Embodiment A, wherein the closing feature includes a coiled spring attached to an interior surface of the housing and an interior surface of the lid.

### ALTERNATIVE EMBODIMENT D

The cartridge of Alternative Embodiment A, wherein the lid is adapted to form a seal with the housing.

### ALTERNATIVE EMBODIMENT E

The cartridge of Alternative Embodiment A, wherein the closing feature is an external closing feature.

### ALTERNATIVE EMBODIMENT F

The cartridge of Alternative Embodiment A, wherein the closing feature is an internal closing feature.

### ALTERNATIVE EMBODIMENT G

The cartridge of Alternative Embodiment A, wherein the test sensors are electrochemical test sensors.

### ALTERNATIVE EMBODIMENT H

The cartridge of Alternative Embodiment A, wherein the test sensors are optical test sensors.

### Alternative Process I

A method of using a test-sensor cartridge including a housing forming a cavity adapted to contain a plurality of test sensors adapted to assist in determining an analyte concentration of a fluid sample, the cartridge further including a lid enclosing the cavity, the lid being hingedly coupled to the housing, the method comprising the acts of:
applying a force to the lid to open the lid, the force causing a closing feature to become distorted, a first end of the closing feature being attached to the housing and a second, opposing end of the closing feature being attached to the lid;
removing a test sensor from the cavity while applying the force to the lid; and
releasing the force to close the lid, the releasing causing the closing feature to generally recover its initial shape.

### Alternative Process J

The method of Alternative Process I, wherein the closing feature includes a flat spring being attached to the housing and the lid.

### Alternative Process K

The method of Alternative Process I, wherein the closing feature includes a coiled spring attached to an interior surface of the housing and an interior surface of the lid.

### Alternative Process L

The method of Alternative Process I, wherein the lid is adapted to form a seal with the cartridge housing.

### Alternative Process M

The method of Alternative Process I, wherein the closing feature is an external closing feature.

### Alternative Process N

The method of Alternative Process I, wherein the closing feature is an internal closing feature.

### Alternative Process O

The method of Alternative Process I, wherein the test sensors are electrochemical test sensors.

### Alternative Process P

The method of Alternative Process I, wherein the test sensors are optical test sensors.

### Alternative Process Q

A method of making a test-sensor cartridge comprising the acts of:
providing a housing forming a cavity adapted to contain a plurality of test sensors adapted to assist in determining an analyte concentration of a fluid sample;
enclosing the cavity using a lid, the lid being hingedly coupled to the housing; and
coupling a closing feature to the housing and the lid, the closing feature being adapted to maintain the lid in a closed position,
wherein the closing feature is distorted when the lid is in an open position and is generally released when the lid is in a closed position.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents, and alternatives falling within the spirit and scope of the invention as defined by the appended claims.

1. A test-sensor cartridge comprising:
a plurality of test sensors adapted to assist in determining an analyte concentration of a fluid sample;
a housing forming a cavity, the cavity being adapted to contain the plurality of test sensors;
a lid adapted to enclose the cavity; and
a closing feature adapted to maintain the lid in a closed position, the closing feature being distorted when the lid is in an open position and generally released when the lid is in a closed position.

2. The cartridge of claim 1, wherein the closing feature includes a flat spring being attached to the housing and the lid.

3. The cartridge of claim 1, wherein the closing feature includes a coiled spring attached to an interior surface of the housing and an interior surface of the lid.

4. The cartridge of claim 1, wherein the lid is adapted to form a seal with the housing.

5. The cartridge of claim 1, wherein the closing feature is an external closing feature.

6. The cartridge of claim 1, wherein the closing feature is an internal closing feature.

7. The cartridge of claim 1, wherein the test sensors are electrochemical test sensors.

8. The cartridge of claim 1, wherein the test sensors are optical test sensors.

9. A method of using a test-sensor cartridge including a housing forming a cavity adapted to contain a plurality of test sensors adapted to assist in determining an analyte concentration of a fluid sample, the cartridge further including a lid enclosing the cavity, the lid being hingedly coupled to the housing, the method comprising the acts of:
applying a force to the lid to open the lid, the force causing a closing feature to become distorted, a first end of the closing feature being attached to the housing and a second, opposing end of the closing feature being attached to the lid;
removing a test sensor from the cavity while applying the force to the lid; and
releasing the force to close the lid, the releasing causing the closing feature to generally recover its initial shape.

10. The method of claim 9, wherein the closing feature includes a flat spring being attached to the housing and the lid.

11. The method of claim 9, wherein the closing feature includes a coiled spring attached to an interior surface of the housing and an interior surface of the lid.

12. The method of claim 9, wherein the lid is adapted to form a seal with the cartridge housing.

13. The method of claim 9, wherein the closing feature is an external closing feature.

14. The method of claim 9, wherein the closing feature is an internal closing feature.

15. The method of claim 9, wherein the test sensors are electrochemical test sensors.

16. The method of claim 9, wherein the test sensors are optical test sensors.

17. A method of making a test-sensor cartridge comprising the acts of:
providing a housing forming a cavity adapted to contain a plurality of test sensors adapted to assist in determining an analyte concentration of a fluid sample;
enclosing the cavity using a lid, the lid being hingedly coupled to the housing; and
coupling a closing feature to the housing and the lid, the closing feature being adapted to maintain the lid in a closed position,
wherein the closing feature is distorted when the lid is in an open position and is generally released when the lid is in a closed position.
